(19) United States
(12) Patent Application Publication
(10) Pub. No.: US 2006/0179899 A1
(43) Pub. Date: Aug. 17, 2006

(54) Cable lock

(76) Inventor: Chun Te Yu, Fusing Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/397,696

(22) Filed: Apr. 5, 2006

Related U.S. Application Data
(63) Continuation-in-part of application No. 10/962,527, filed on Oct. 13, 2004, now Pat. No. 7,047,772.

(51) Int. Cl. E05B 37/02

(52) U.S. Cl. 70/21

(57) ABSTRACT

A cable lock includes a case, a locking device and an elastic cable. The case includes a first side and a second side extending from the first side at an angle, a slot defined in the first side, an opening defined in the second side and in communication with the slot. The locking device is positioned in the case for opening and shutting the opening. The elastic cable includes a fixed end secured to the case and a free end formed with a head and a neck of a reduced diameter. Thus, the head can be moved into the case through the opening while the neck is moved in and along the slot. Moreover, the head can automatically be moved out of the case through the opening while the neck is moved out along the slot.

### CROSS-REFERENCE

The present application is a continuation application of U.S. patent application Ser. No. 10/962,527.

### BACKGROUND OF INVENTION

1. Field of Invention

The present invention relates to a cable lock easily operable by only one hand.

2. Related Prior Art

Referring to FIG. 11, shown is a conventional cable lock including a case 6, a locking device and a cable 61. The case 6 defines a slot 62 and an opening 621 in communication with the slot 62. The width of the slot 62 is smaller than the diameter of the opening 621. The locking device is positioned in the case 6 and includes three dial rings that are however exposed from the case 6 to be dialed by a user. The cable 61 includes a fixed end secured to the case 6 and a free end 611 for detachable insertion into the case 6. The free end 611 of the cable 61 includes a head and a neck formed next to the head. When wanting to lock, the user inserts the head of the free end 611 of the elastic cable into the case through the opening 621, moves the neck of the free end 611 of the cable 61 into the slot 62 from the opening 621, and dials the dial rings of the locking device so as to shut the opening 621. Wishing to unlock, the user dials the dial rings of the locking device with one hand. This is however inconvenient for the user under some conditions. Because of its elasticity, the cable 61 will stretch when it is released from a bent position. However, since the slot 62 is further from the fixed end of the cable 61 than the opening 621 is, the stretching of the cable 61 will cause the neck of the free end 611 to be trapped in the slot 62 and the head of the free end 611 to be confined in the case 6. Therefore, the user is forced to disengage the free end 611 of the cable 61 from the case 6 with the other hand.

Disclosed in U.S. Pat. No. 6,742,366 is a locking and securing system for slot-bearing products. The locking and securing system includes a padlock 21 and a cable 22. The cable 22 includes a loop-defining plate 25 at an end and an end cap 27 at the other end. In use, the cable 22 is wound around an external fixed object such as a post. The end cap 27 is directed through the loop-defining plate 25 so as to form a loop around the external object. The end cap 27 is directed to a securing member 23 secured to a precious item such as a laptop computer 24. Finally, the end cap 27 is engaged with the padlock 21. The loop 25 is not secured to the pad lock 21. Therefore, the cable 22 can be completely separated from the padlock 21 and lost. Moreover, a user has to disengage the end cap 28 from the padlock 21 personally.

The present invention is therefore intended to obviate or at least alleviate the problems encountered in prior art.

### SUMMARY OF INVENTION

It is the primary objective of the present invention to provide a cable lock easily operable with only one hand.

According to the present invention, a cable lock includes a case, a locking device and an elastic cable. The case includes a first side and a second side extending from the first side at an angle, a slot defined in the first side, an opening defined in the second side and in communication with the slot. The locking device is positioned in the case for opening and shutting the opening. The elastic cable includes a fixed end secured to the case and a free end formed with a head and a neck of a reduced diameter. Thus, the head can be moved into the case through the opening while the neck is moved in and along the slot. Moreover, the head can automatically be moved out of the case through the opening while the neck is moved out along the slot.

Other objectives, advantages and features of the present invention will become apparent from the following description referring to the attached drawings.

### BRIEF DESCRIPTION OF DRAWINGS

The present invention will be described through detailed illustration of two embodiments referring to the drawings.

FIG. 1 is an exploded view of a cable lock according to the first embodiment of the present invention.

FIG. 2 is a perspective view of the cable lock shown in FIG. 1.

FIG. 3 is a cross-sectional view of the cable lock shown in FIG. 2 in a locking position.

FIG. 4 is a cross-sectional view of the cable lock shown in FIG. 2 in a releasing position.

FIG. 5 is an exploded view of a cable lock according to the second embodiment of the present invention.

FIG. 6 is a perspective view of the cable lock shown in FIG. 5.

FIG. 7 is a cross-sectional view of the cable lock shown in FIG. 6, with a first locking device in a locking position.

FIG. 8 is a cross-sectional view of the cable lock shown in FIG. 6, with the first locking device in a releasing position.

FIG. 9 is a cross-sectional view of the cable lock shown in FIG. 6, with a second locking device in a locking position.

FIG. 10 is a cross-sectional view of the cable lock shown in FIG. 6, with a second locking device in a releasing position.

FIG. 11 is a perspective view of a conventional cable lock.

### DETAILED DESCRIPTION OF EMBODIMENTS

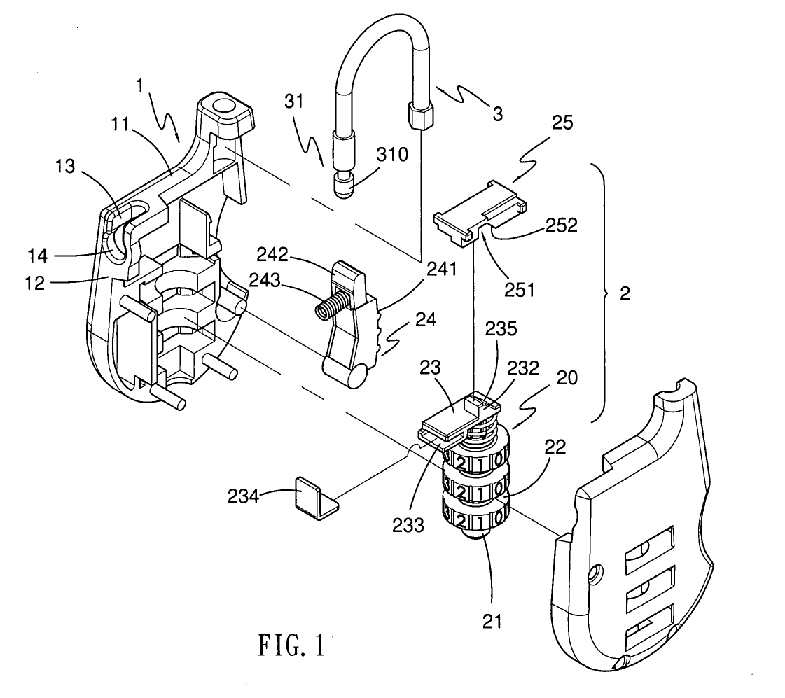

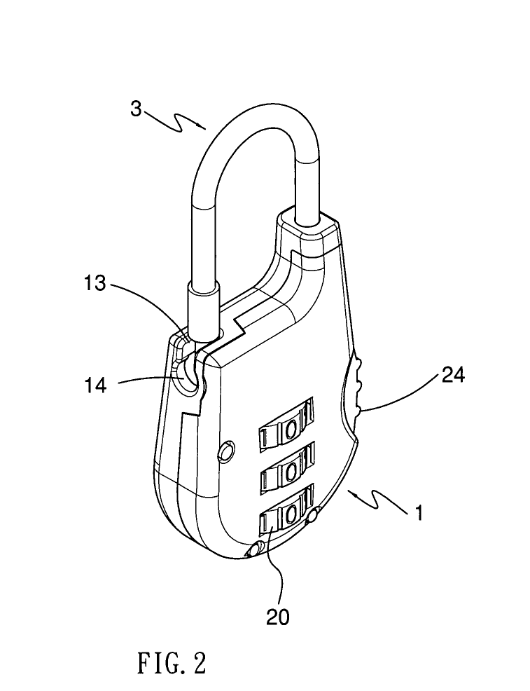

Referring to FIGS. 1 through 4, shown is a cable lock according to a first embodiment of the present invention. The cable lock includes a case 1, a locking device 2 and an elastic cable 3.

The case 1 is assembled from two shells. The case 1 includes a first side 11 and a second side 12 substantially extending in perpendicular to the first side 11. The case 1 defines a slot 13 through the first side 11 and an opening 14 through the second side 12. The slot 13 is in communication with the opening 14. The width of the slot 13 is smaller than the diameter of the opening 14.

The locking device 2 is substantially positioned in the case 1. The locking device 2 includes a combination unit 20 consisting of a rod 21 and a plurality of dial rings 22. The rod 21 is positioned in the case 1. The dial rings 22 are installed around the rod 21. The dial rings 22 are however exposed from the case 1 to be dialed by a user.

Furthermore, the locking device includes a top plate 23, a shutter 234, an action plate 25 and a button 24. The top plate 23 is connected to an upper end of the rod 21. The top plate 23 includes a wedge 232 formed thereon and formed with an inclined face 235. The top plate 23 defines a slit 233 at an end. The shutter 234 includes a bent configuration with a first section inserted in the slit 233 and a second section for shutting the opening 14.

The action plate 25 defines a recess 251 on an underside. The recess 251 is defined by an inclined face 252. The action plate 25 is movably installed on the top plate 23 while the recess 251 receives the wedge 232 and the inclined face 252 contacts the inclined face 235. Thus, when the action plate 25 is moved on the top plate 23 in a first direction, the action plate 25 pushes the top plate 23 in a second direction perpendicular to the first direction.

The button 24 is pivotally installed on the case 1 to be pushed. The button 24 includes a skid-proof face 241 for contact with the user's finger, a pushing end 242 for pushing the action plate 25 and a spring 243 attached thereto and compressed between the button 24 and a portion of the case 1.

The elastic cable 3 by nature is flexible and elastic. The elastic cable 3 is flexible so that it can be bent. The elastic cable 3 is elastic so that it will stretch when it is released. The elastic cable 3 includes a fixed end secured to the case 1 and a free end 31 detachably inserted into the case 1. The free end 31 of the elastic cable 3 includes a head 310 and a neck formed next the head 310. The diameter of the head 310 is larger than that of the neck of the free end 31 of the elastic cable 3.

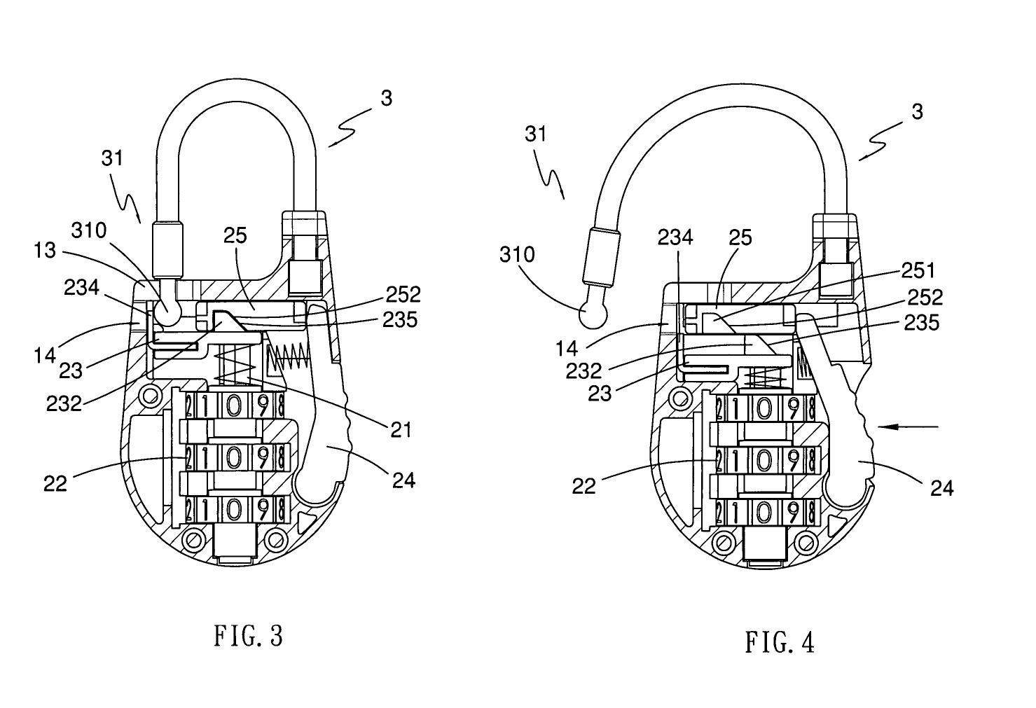

Referring to FIG. 3, the head 310 is inserted in the case 1 through the opening 14 while the neck of the free end 31 of the elastic cable 3 is located in the slot 13. The opening 14 is closed by the second section of the shutter 234. Thus, the head 310 is confined in the case 1.

Referring to FIG. 4, a correct combination of dials is entered through the dial rings 22 so that the rod 21 can be moved with respect to the dial rings 22. The button 24 is pushed so that the action plate 25 is moved. The inclined face 252 moves on the inclined face 235 so that the action plate 25 pushes the top plate 23. The top plate 23 moves the shutter 234 by the first section so that the second section of the shutter 234 leaves the opening 14. Because of its elasticity, the cable 3 stretches and therefore disengages the head 310 from the case 1 through the opening 14 while the neck of the free end 31 of the elastic cable 3 is moved out along the slot 13. Therefore, the user can easily operate the cable lock with only one hand.

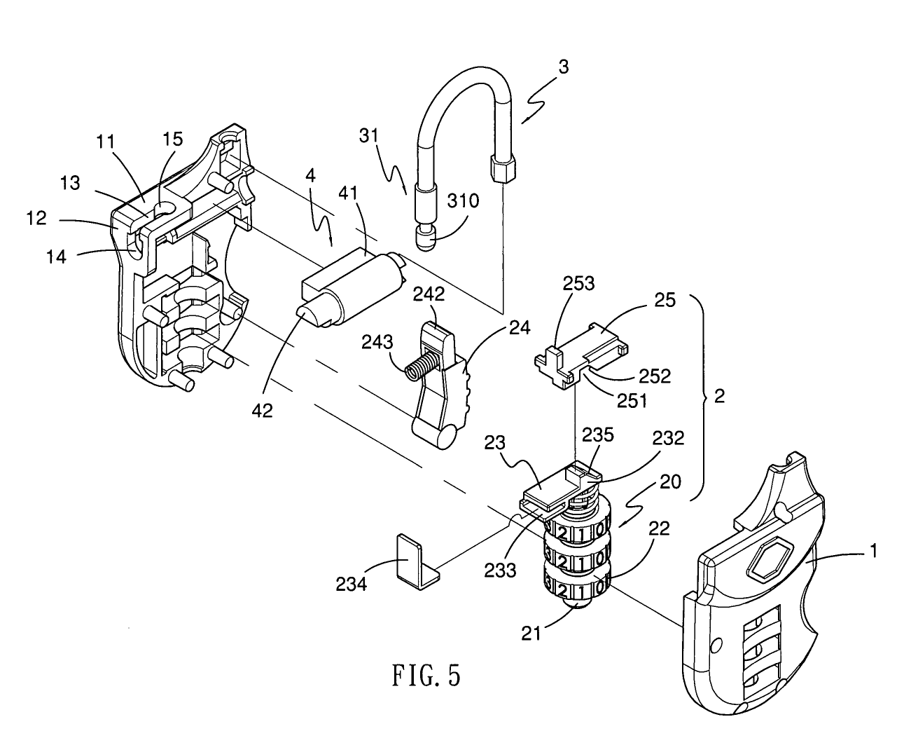

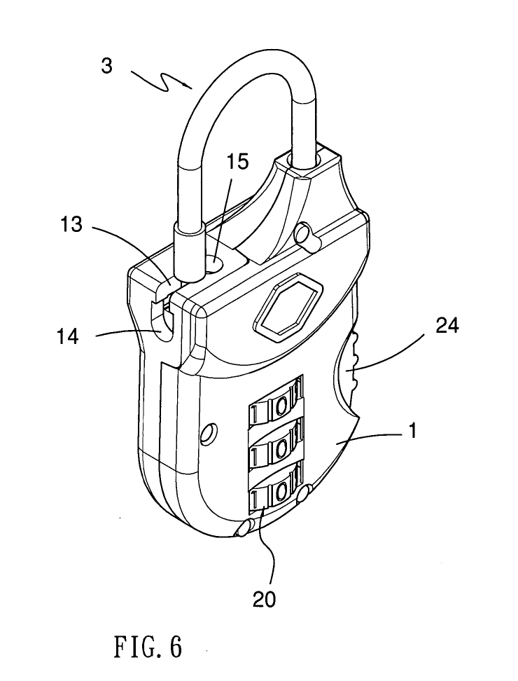

Referring to FIGS. 5 through 10, shown is a cable lock according to a second embodiment of the present invention that is like the first embodiment except a few things.

The case 1 of the second embodiment defines an opening 15 through the first side 11 and in communication with the slot 13. The head 310 can be inserted into the case 1 through the opening 15.

The second embodiment includes a locking device 4 in addition to the locking device 2. In the second embodiment, the locking device 2 will be referred to as the “first locking device 2” while the locking device 4 will be called the “second locking device 4.”

The first locking device 2 of the second embodiment is like the single locking device 2 of the first embodiment except that the action plate 25 of the first locking device 2 of the second embodiment includes an extension 253 formed thereon for pushing the head 310.

The second locking device 4 includes a core 41 substantially located in the case 1 yet exposed from the case 1 for receiving a key and a tongue 42 rotationally connected to the core 41 between a locking position and a releasing position.

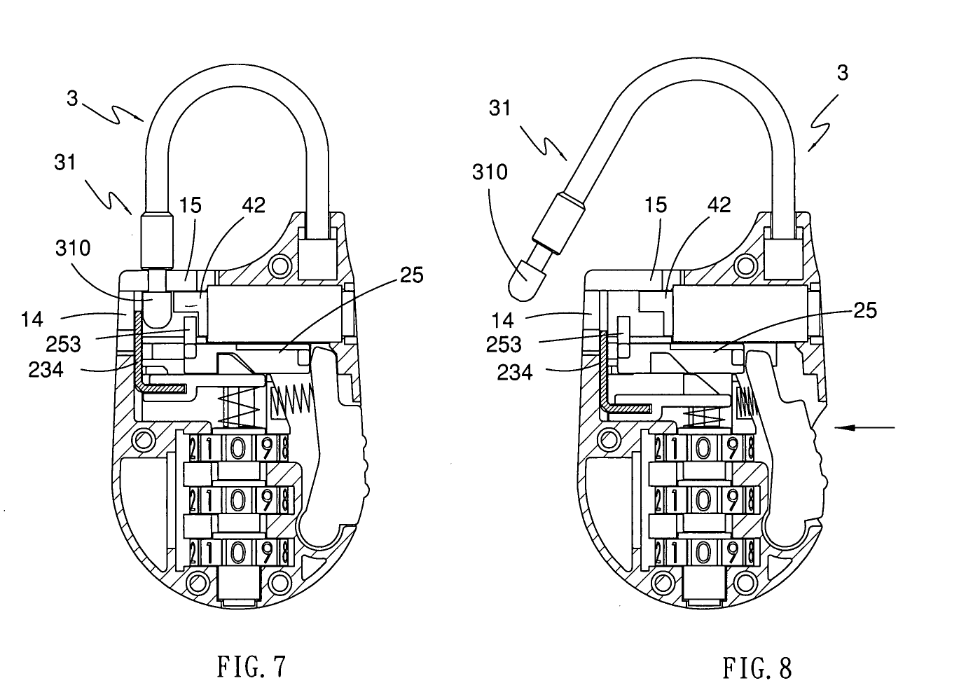

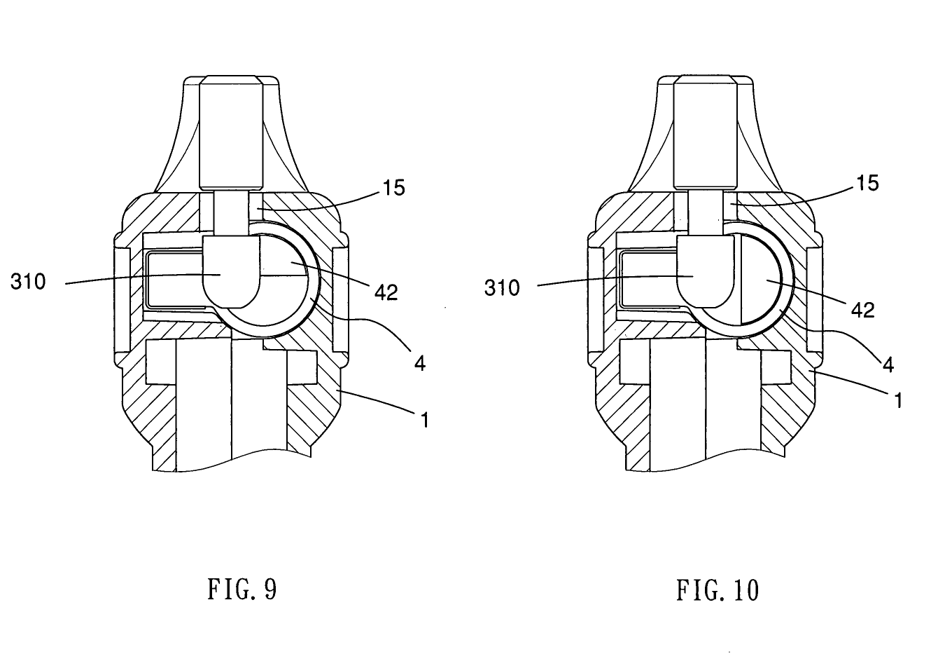

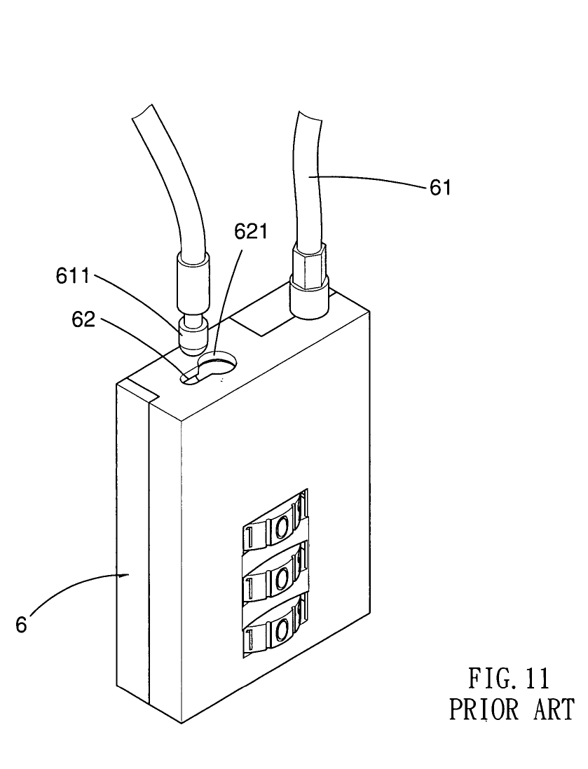

FIGS. 7 and 8 show the operation of the first locking device 2 while FIGS. 9 and 10 show the operation of the second locking device 2. It should be noted that when the first locking device 2 is switched between the locking and releasing positions, the second locking device 4 should be kept in the locking position. When the second locking device 4 is switched between the locking and releasing positions, the first locking device 2 should be kept in the locking position.

The operation of the first locking device 2 of the second embodiment will not be described in detail for its similarity to that of the single locking device 2 of the first embodiment shown in FIGS. 3 and 4. It should however be noted that the extension 253 of the action plate 25 of the first locking device pushes the head 310 from the case 1.

Referring to FIG. 9, in the locking position of the second locking device 4, the tongue 42 shuts the opening 15 so as to confine the head 310 in the case 1. Referring to FIG. 10, in the releasing position of the second locking device 4, the key is inserted and turned in the core 41 so as to move the tongue 42 from the opening 15, thus allowing the head 310 to be disengaged from the case 1.

The present invention has been described through the illustration of the embodiments. Those skilled in the art can derive variations from the embodiments without departing from the scope of the present invention. Therefore, the embodiments shall not limit the scope of the present invention defined in the claims.

1. A cable lock comprising:
a case including a first side and a second side extending from the first side at an angle, a slot defined in the first side, an opening defined in the second side and in communication with the slot;
a locking device positioned in the case for opening and shutting the opening; and
an elastic cable comprising a fixed end secured to the case and a free end formed with a head and a neck of a reduced diameter so that the head can be moved into the case through the opening while the neck is moved in and along the slot and that the head can automatically be moved out of the case through the opening while the neck is moved out along the slot.
